(19) United States
(12) Patent Application Publication
(10) Pub. No.: US 2019/0370921 A1
(43) Pub. Date: Dec. 5, 2019

(54) SYSTEM AND METHOD FOR VEHICLE ALLOCATION TO PASSENGERS

(71) Applicant: ANI TECHNOLOGIES PRIVATE LIMITED, Bengaluru (IN)

(72) Inventors: Alok Nigam, Lucknow (IN); Hem Narayan, Patna (IN); Rishabh Katiyar, Kanpur (IN)

(73) Assignee: ANI Technologies Private Limited

(21) Appl. No.: 16/101,123

(22) Filed: Aug. 10, 2018

(30) Foreign Application Priority Data
Jun. 1, 2018 (IN) 201841020553

(51) Int. Cl. G06Q 50/30; G06Q 10/06; G08G 1/123

(52) U.S. Cl. CPC G06Q 50/30; G01C 21/36; G08G 1/123; G06Q 10/06315

(57) ABSTRACT

A method and a system for allocating co-passengers in a ride-sharing system are provided. A booking request including source and destination locations of a passenger is received for a share-ride. Based on the booking request, a route including pick-up and drop-off locations from a set of routes is selected. A time duration is determined for the passenger to reach the pick-up location from the source location. Further, a time duration is determined for each vehicle of a set of vehicles to reach the pick-up location from their respective current locations. Based on the time durations, a vehicle from the set of vehicles is allocated to the passenger for the share-ride.

### CROSS-RELATED APPLICATIONS

This application claims priority of Indian Application Serial No. 201841020553, filed Jun. 1, 2018, the contents of which are incorporated herein by reference.

### FIELD OF THE INVENTION

The present invention relates generally to ride-sharing systems, and more particularly, to a method and a system for allocating vehicles to passengers in a ride-sharing system.

### BACKGROUND

With the improvement in lifestyles of individuals and limited alternatives of public or private transportation, popularity of cab services is continuously increasing for travel between source and destination locations. Generally, the individuals avail various public and private transportation services for making trips to and from work places or for personal commute and travel. In modern cities, vehicle service providers, such as a cab service provider, play an important role by providing on-demand vehicle services to the individuals to travel between the source and destination locations. The cab service provider deploys a set of cabs (e.g., cars) in a geographical area to supply to the demands from the individuals.

The individuals initiate the demands for the vehicle services by means of mobile or web applications associated with the vehicle service providers. Generally, bookings of the vehicles are performed on an individual basis, in which a passenger or a small group of passengers travelling towards the same destination book a vehicle. When bookings are made on the individual basis, most of the vehicles tend to travel with minimum occupancy. Thus, in the event of an increased demand for the vehicle services at any given time, the number of vehicles operating in a particular geographical area also increases. This results in high traffic congestions along various roads along with an increase in carbon dioxide (CO₂) emissions from the vehicles. Thus, various environmental problems, such as air pollution or global warming, have severely increased that are affecting the environment and daily lives of the individuals. To encounter such problems, various cab service providers are following a ride-sharing approach where the individuals can share the ride with other individuals. Such a ride-sharing approach may help in reducing the number of cabs that operate in the geographical area, thereby reducing the effects of various environmental problems. Furthermore, in a ride-sharing system, a ride-fare is divided among the multiple individuals who are sharing a vehicle. Thus, each individual has to spend less money as compared to a scenario when each individual books the vehicle on individual basis.

However, in recent times in the ride-sharing system, the individuals are facing discomforts while sharing the vehicle with other individuals. Such discomforts arise mainly due to long ride durations, and when a driver of the vehicle has to follow long deviations from the routes of the individuals to pick-up other individuals. Furthermore, the vehicle is driven through narrow lanes to pick-up other individuals, thereby adding more delay to the ride durations. Also, the increased traffic conditions along the various routes and lanes further delay the drop of the individuals to their destination locations on time, and subsequently can become frustrating and troublesome for the individuals. Such discomforts may discourage the individuals from taking up ride-sharing in the future that may not be desirable for the cab service provider.

In light of the foregoing, there exists a need for a technical and more reliable solution that solves the above-mentioned problems and manages allocation of vehicles to passengers in a ride-sharing system. The allocation of vehicles should be managed that minimizes discomforts, improves share-ride experiences of the passengers during ride-sharing, and maximizes ride-sharing bookings in a geographical area. Such management of vehicles may help in reducing the number of vehicles that can operate in the geographical area, thereby reducing the effects of various environmental problems.

### SUMMARY

In an embodiment of the present invention, a vehicle allocation method and a system for allocating vehicles to passengers are provided. The method includes one or more operations that are executed by circuitry of the system to receive a booking request for a ride that includes source and destination locations of a passenger. The circuitry selects a route including pick-up and drop-off locations from a set of routes. The route is selected from the set of routes based on the source and destination locations associated with the booking request such that a first distance between the source and pick-up locations is less than a first threshold distance and a second distance between the destination and drop-off locations is less than a second threshold distance. The circuitry further determines a first time duration including a buffer time duration for reaching the pick-up location by the passenger from the source location based on the first distance. The circuitry further determines a second time duration for each vehicle from a set of vehicles that is behind the pick-up location and is traveling towards the drop-off location along the selected route. The second time duration is determined based on a vehicle time duration of each vehicle for reaching the pick-up location from a current location of each vehicle and a waiting time duration of each vehicle at the pick-up location. The circuitry further allocates a vehicle from the set of vehicles to the passenger for the ride along the selected route. The vehicle is allocated based on the first and second time durations, when the second time duration is greater than or equal to the first time duration and the vehicle is nearest to the pick-up location among the set of vehicles in terms of distance.

Various embodiments of the present invention provide methods and systems for allocating vehicles to passengers that simplify booking of the vehicles by the passengers. The system comprises circuitry to perform one or more operations and is configured to receive the booking request for the ride that includes source and destination locations of the passenger. Further, the route including pick-up and drop-off locations is selected from the set of routes based on the source and destination locations associated with the booking request. The route is selected such that the first distance between the source and pick-up locations is less than the first threshold distance and a second distance between the destination and drop-off locations is less than the second threshold distance. The set of routes are identified in a geographical area based on a density of historical pick-up and drop-off locations associated with the geographical area. Also, each route from the set of routes is a fixed route that includes one or more pick-up and drop-off locations that are dynamically identified based on one or more shortest approachable location points along each route from one or more source or destination locations associated with one or more booking requests. Further, the first time duration for reaching the pick-up location by the passenger from the source location is determined based on the first distance. The first time duration is further determined based on a walking speed of the passenger.

Further, the circuitry determines the second time duration for each vehicle that is behind the pick-up location and is traveling towards the drop-off location along the selected route. The second time duration is determined based on a vehicle time duration for reaching the pick-up location from the current location of each vehicle and a waiting time duration of each vehicle at the pick-up location. The vehicle time duration of each vehicle is determined based on at least a third distance between the current and pick-up locations and a real time traffic condition between the current and pick-up locations. Further, a vehicle from the set of vehicles is allocated to the passenger for the ride along the selected route based on the first and second time durations, when the second time duration associated with the vehicle is greater than or equal to the first time duration associated with the passenger and the vehicle is nearest to the pick-up location among the set of vehicles in terms of distance. The vehicle is also allocated to the passenger based on the drop-off locations of other passengers in the vehicle. Further, an allocation information is transmitted to the passenger device. The allocation information includes the pick-up and drop-off locations for the ride, a ride-start time from the pick-up location, vehicle information of the allocated vehicle, and driver information of a driver of the allocated vehicle. Further, direction information is transmitted to the passenger device for directing the passenger from the source location to the pick-up location. Further, a new vehicle may be allocated to the passenger for the ride along the selected route when the set of vehicles is unavailable for providing the ride to the passenger along the selected route.

Thus, the method and the system of the present invention effectively allocate vehicles to passengers in a ride-sharing system that minimize discomforts and improves share-ride experiences of the passengers. The vehicles are allocated to the passengers that operate along a fixed route, thereby eliminating deviations along the route while transporting the passengers. Further, waiting times of the driver or the passengers at the pickup area and total ride time durations for the passengers are minimized, which in turn maximize ride-sharing bookings in a geographical area. The method and system of the present invention further control and manage the movement of the vehicles along the selected route based on real-time requirements initiated by the passengers.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

FIG. 1 is a block diagram that illustrates an environment in which various embodiments of the present invention are practiced;

FIG. 2 is a block diagram that illustrates an application server of the environment of FIG. 1, in accordance with an embodiment of the present invention;

FIG. 3 is a flow chart that illustrates a method for allocating a vehicle to a passenger of the environment of FIG. 1, in accordance with an embodiment of the present invention;

FIG. 4 is an exemplary environment that illustrates selection of a route from a set of routes in a geographical area, in accordance with an embodiment of the present invention;

FIG. 5 is an exemplary environment that illustrates allocation of a vehicle to a passenger in a geographical area, in accordance with an embodiment of the present invention; and

FIG. 6 is a block diagram that illustrates a computer system for allocating a vehicle to a passenger in a ride-sharing system, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention uses a combination of system components, which constitutes systems and methods for allocating vehicles to passengers along a fixed route in a ride-sharing system. Accordingly, the components and the method steps have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Terms Description (in Addition to Plain and Dictionary Meaning)

Vehicle is a means of transport that is deployed by a vehicle transit system, such as a vehicle service provider, to provide vehicle services to one or more passengers. For example, the vehicle is an automobile, a bus, a car, a bike, or the like. The one or more passengers may travel in the vehicle to commute between source and destination locations.

Booking request is a request for a ride, for example, a share-ride or a non-share ride, requested by a passenger to travel from one location to another location. The booking request includes at least one of a source location, a destination location, a vehicle type, or the like.

Source location is a point of location in a geographical area at which a passenger is currently located. The passenger initiates a booking request from the source location.

Destination location is a point of location in a geographical area where a passenger wants to travel from a source location. The passenger provides the destination location while initiating a booking request from the source location.

Pick-up location is a point of location in a geographical area from where a passenger takes a vehicle for a ride. Prior to taking up the vehicle, the passenger initiates a request for the ride from a source location. In one embodiment, the source and pick-up locations may be the same location. In another embodiment, the source and pick-up locations may be different locations and are within a defined threshold distance.

Drop-off location is a point of location in a geographical area at which a passenger comes out of the vehicle after completion of a ride requested by the passenger. The requested ride includes a destination location of the passenger. In one embodiment, the destination and drop-off locations may be the same location. In another embodiment, the destination and drop-off locations may be different locations and are within a defined threshold distance.

First distance is a distance between a source location and a pick-up location associated with a ride requested by a passenger. The passenger travels, for example, walks the first distance (i.e., from the source location to the pick-up location) to take up a vehicle allocated for the ride.

Second distance is a distance between a destination location and a drop-off location associated with a ride requested by a passenger. The passenger travels, for example, walks the second distance (i.e., from the drop-off location to the destination location) to reach his or her destination.

Third distance is a distance between a current location of a vehicle to be allocated to a passenger for a ride and a pick-up location associated with the ride.

First time duration is a total time duration that is provided to a passenger for reaching a pick-up location from a source location associated with a ride. The first time duration includes a travel time duration and a buffer time duration. The travel time duration may be determined based on a walking speed of the passenger and a distance between the pick-up and source locations.

Buffer time duration is an additional time duration other than a travel time duration computed for a passenger that is provided to the passenger for reaching a pick-up location from a source location.

Second time duration is a total time duration that is provided to a driver of a vehicle to drive the vehicle and reach a pick-up location from its current location. Thereafter, the driver may pick-up a passenger who has requested for a ride from the pick-up location, and then leave the pick-up location towards a drop-off location. The second time duration includes a vehicle time duration and a waiting time duration.

Vehicle time duration is a time duration that is provided to a driver of a vehicle to drive the vehicle for reaching a pick-up location from its current location. The vehicle time duration may be determined based on a distance between a current location of the vehicle and a pick-up location, real-time traffic conditions between the current and pick-up locations, and an average speed of the vehicle.

Waiting time duration is a time duration for which a driver of a vehicle waits for a passenger at a pick-up location associated with a ride requested by the passenger.

Allocation information is information associated with allocation of a vehicle to a passenger. The allocation information includes at least one of pick-up and drop-off locations of a ride, a ride-start time from the pick-up location, vehicle information of the allocated vehicle, driver information of a driver of the allocated vehicle, or passenger information of the passenger.

Direction information is information including at least one direction for travelling from one location to another location. For example, a passenger uses the direction information to travel from a source location to a pick-up location. Similarly, a driver of a vehicle allocated to the passenger uses the direction information to drive the vehicle from the pick-up location to a drop-off location requested by the passenger. The direction information may be provided in the form of a graphical representation, a text-based representation, a voice-based representation, or a combination thereof.

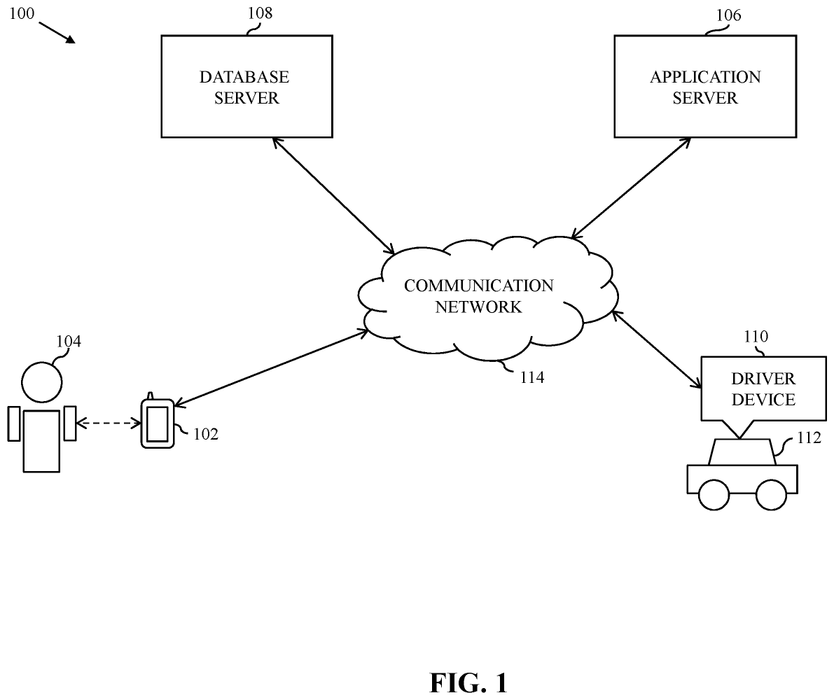

Referring now to FIG. 1, a block diagram that illustrates an environment 100 in which various embodiments of the present invention are practiced, is shown. The environment 100 includes a passenger device 102 associated with a passenger 104, an application server 106, a database server 108, and a driver device 110 associated with a vehicle 112. The passenger device 102, the application server 106, the database server 108, and the driver device 110 communicate with each other by way of a communication network 114. Examples of the communication network 114 include, but are not limited to, a wireless fidelity (Wi-Fi) network, a light fidelity (Li-Fi) network, a satellite network, the Internet, a mobile network such as a cellular data network, a high speed packet access (HSPA) network, or any combination thereof. The driver device 110 may be associated with a driver of the vehicle 112.

The passenger device 102 is a computing device that is used by the passenger 104 to perform one or more activities. For example, the passenger 104 uses the passenger device 102 to initiate a booking request for a ride between source and destination locations. The passenger 104 may initiate the booking request by means of a service application installed on the passenger device 102. To schedule the ride, the passenger 104 inputs details of the booking request including at least one of a source location, a destination location, a vehicle type, a preferred pick-up time, or the like, by means of the installed service application. In another embodiment, the passenger 104 may use the passenger device 102 to input the details of the booking request by means of a web application. The passenger device 102 transmits the booking request to the application server 106 over the communication network 114. In another embodiment, the service or web application transmits the booking request to the application server 106 by means of the passenger device 102 over the communication network 114.

Further, the passenger 104 uses the passenger device 102 to view a notification message that includes at least one of allocation or direction information associated with the booking request. The allocation information includes at least one of pick-up and drop-off locations for the ride, a ride-start time from the pick-up location, vehicle information of an allocated vehicle for the ride, such as the vehicle 112, or driver information of the driver of the vehicle 112. The direction information may indicate a direction for travelling from the source location to the pick-up location by the passenger 104. The direction information may be provided to the passenger 104 in the form of a graphical representation, a text-based representation, a voice-based representation, or a combination thereof. Examples of the passenger device 102 include, but are not limited to, a personal computer, a laptop, a smartphone, a tablet, and the like.

The application server 106 is a computing device, a software framework, or a combination thereof, that may provide a generalized approach to create the application server implementation. In an embodiment, the operation of the application server 106 may be dedicated to execution of procedures, such as, but not limited to, programs, routines, or scripts stored in a memory for supporting its applied applications. In an embodiment, the application server 106 receives the booking request for the ride from the passenger device 102 over the communication network 114. The application server 106 selects a route from a set of routes based on the source and destination locations associated with the booking request. The selected route includes the pick-up and drop-off locations for the ride and is selected from the set of routes such that a first distance between the source and pick-up locations is less than a first threshold distance and a second distance between the destination and drop-off locations is less than a second threshold distance. In an embodiment, each route of the set of routes is a fixed route, for example, the route selected from the set of routes. The fixed route includes one or more pick-up and drop-off locations, such as the pick-up and drop-off location, that are dynamically identified based on one or more shortest approachable location points along each route from one or more source or destination locations, such as the source and destination locations, associated with one or more booking requests, such as the booking request initiated by the passenger 104.

Further, in an embodiment, the applications server 106 determines a first time duration for reaching the pick-up location by the passenger 104 from the source location. The first time duration includes a travel time duration that may be determined based on the first distance between the source and pick-up locations and a walking speed of the passenger 104. The first time duration further includes a buffer time duration i.e., an extra time provided to the passenger 104 in addition to the travel time duration for reaching the pick-up location from the source location. In an embodiment, the application server 106 further determines a second time duration for each vehicle from a set of vehicles that is behind the pick-up location (i.e., approaching the pick-up location) and is traveling towards the drop-off location along the selected route (which is a fixed route). The second time duration may be determined based on a vehicle time duration and a waiting time duration of each vehicle. The vehicle time duration is a total time that may be taken by the driver of each vehicle to drive the corresponding vehicle and reach the pick-up location from its current location. The waiting time duration is a total time for which the driver of each vehicle may wait for one or more passengers, such as the passenger 104, at the pick-up location before leaving the pick-up location for the next stoppage.

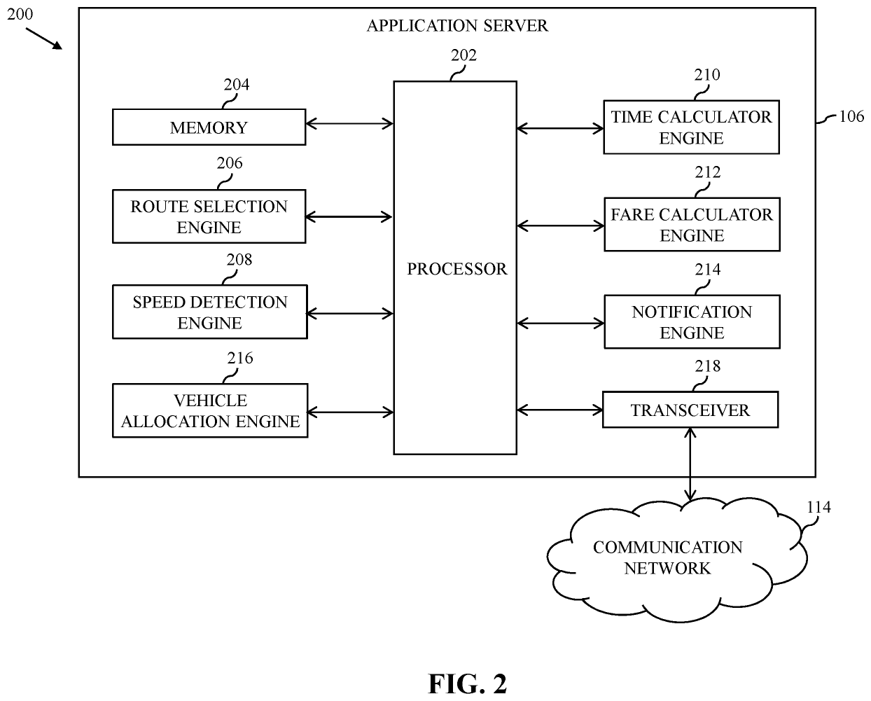

Further, in an embodiment, the application server 106 allocates a vehicle, such as the vehicle 112 selected from the set of vehicles, to the passenger 104 for the ride along the selected route. The vehicle 112 is allocated to the passenger 104 based on at least the first and second time durations, when the second time duration is greater than or equal to the first time duration and the vehicle 112 is nearest to the pick-up location among the set of vehicles in terms of distance. After the vehicle 112 is allocated to the passenger 104, the application server 106 transmits the allocation information to the passenger device 102 or the driver device 110. The application server 106 may further transmit the direction information to the passenger device 102 for directing the passenger 104 from the source location to the pick-up location. The application server 106 may further transmit direction information to the driver device 110 for directing the driver from its current location to the pick-up location or from the pick-up location to the drop-off location. Various operations of the application server 106 have been described in detail in conjunction with FIGS. 2, 3, 4, and 5. Examples of the application server 106 include, but are not limited to, a personal computer, a laptop, or a network of computer systems. The application server 106 may be realized through various technologies such as, but not limited to, a Java web-framework, a .NET framework, a PHP (Hypertext Preprocessor) framework, or any other web-application framework.

The database server 108 is a data management and storage server that manages and stores passenger information of each passenger, driver information of each driver (such as the driver associated with the vehicle 112), and vehicle information of each vehicle (such as the vehicle 112). The database server 108 includes a processor (not shown) and a memory (not shown) for managing and storing the passenger, driver, and vehicle information. For example, the passenger information of the passenger 104 may include a name, a contact number, a passenger rating, or other passenger-related information. The driver information of the driver may include a name, a contact number, a driver rating, or other driver-related information. The vehicle information of the vehicle 112 may include a vehicle type, a vehicle capacity, a vehicle number, or other vehicle-related information.

In an embodiment, the database server 108 further manages and stores historical demands and supplies associated with one or more geographical areas and historical pick-up and drop-off locations associated with each historical demand and supply. The database server 108 further manages and stores traffic conditions along various routes at various time instances provided by one or more servers, such as the application server 106. Further, in an embodiment, the database server 108 may receive a query from the application server 106 over the communication network 114, to retrieve at least one of the stored information, such as the passenger, driver, or vehicle information. The database server 108, in response to the received query from the application server 106, transmits the requested information to the application server 106 over the communication network 114. Examples of the database server 108 include, but are not limited to, a personal computer, a laptop, or a network of computer systems.

The driver device 110 is a computing device that is used by the driver of the vehicle 112 to perform one or more activities. For example, the driver uses the driver device 110 to view the booking request that has been received from the application server 106. The driver further uses the driver device 110 to accept or reject the received booking request, view the passenger information of the passenger 104 based on allocation of the vehicle 112 to the passenger 104, and view the direction between the pick-up and drop-off locations along the selected route. The direction information is provided by the application server 106 or a third-party server (not shown) over the communication network 114. The driver device 110 further transmits real-time booking status and real-time position information to the application server 106 over the communication network 114. The real-time booking status may indicate whether the vehicle 112 is currently occupied with an ongoing booking request or is available for the new booking request. The real-time position information may indicate current position information of the driver device 110, which in turn is indicative of the current position information of the vehicle 112. The driver device 110 includes one or more position-tracking sensors for tracking the real-time position information of the driver device 110 by way of a navigation system, such as a global positioning system (GPS). In an exemplary embodiment, the driver device 110 may be a vehicle head unit. In another exemplary embodiment, the driver device 110 may be a communication device, such as a smartphone, a tablet, or any other portable communication, that is placed in the vehicle 112.

Referring now to FIG. 2, a block diagram 200 that illustrates the application server 106 of the environment 100 is shown, in accordance with an embodiment of the present invention. The application server 106 includes a processor 202, a memory 204, a route selection engine 206, a speed detection engine 208, a time calculator engine 210, a fare calculator engine 212, a notification engine 214, a vehicle allocation engine 216, and a transceiver 218.

The processor 202 includes suitable logic, circuitry, and/or interfaces that are operable to execute instructions, programs, codes, and/or scripts stored in the memory 204 to perform one or more operations. For example, the processor 202 processes the booking request received from the passenger device 102 and determines the source and destination locations and other ride-related preferences of the passenger 104 for the ride. In an embodiment, the processor 202 transmits the allocation and direction information to the passenger device 102 or the driver device 110, based on allocation of the vehicle 112 to the passenger 104. The processor 202 may provide instructions and control commands to other circuitry of the application server 106, such as the memory 204, the route selection engine 206, the speed detection engine 208, the time calculator engine 210, the fare calculator engine 212, the notification engine 214, the vehicle allocation engine 216, or the transceiver 218, for performing their corresponding operations, as described below. Examples of the processor 202 include, but are not limited to, an application-specific integrated circuit (ASIC) processor, a reduced instruction set computing (RISC) processor, a complex instruction set computing (CISC) processor, or a field-programmable gate array (FPGA). It will be apparent to a person skilled in the art that the processor 202 is compatible with multiple operating systems.

The memory 204 includes suitable logic, circuitry, and/or interfaces to store one or more sets of instructions, programs, codes, and/or scripts that are executed by the processor 202, the route selection engine 206, the speed detection engine 208, the time calculator engine 210, the fare calculator engine 212, the notification engine 214, the vehicle allocation engine 216, and the transceiver 218 to perform their operations. The memory 204 further stores the booking request of the passenger 104 received from the passenger device 102. The memory 204 further stores route selection information, speed detection information, time duration information, fare information, allocation information, direction information, or the like. Examples of the memory 204 include, but are not limited to, a random-access memory (RAM), a read-only memory (ROM), a programmable ROM (PROM), an erasable PROM (EPROM), a hard disk drive (HDD), a secure digital (SD) card, and the like.

The route selection engine 206 includes suitable logic, circuitry, interfaces, and/or code that are operable to execute instructions, codes, scripts, and programs stored in the memory 204. The route selection engine 206 identifies the set of routes in a geographical area, for example, based on a density of historical pick-up and drop-off locations associated with the geographical area. Each route in the set of routes is a fixed route along which one or more vehicles are operated by a vehicle service provider (e.g., a cab service provider) for providing vehicle services to the one or more passengers. The one or more vehicles that have been assigned to operate along each route may not operate along remaining routes of the set of routes. The route selection engine 206 further selects the route from the set of routes based on the source and destination locations associated with the booking request. In an embodiment, the route is selected from the set of routes such that the first distance between the source and pick-up locations is less than the first threshold distance and the second distance between the destination and drop-off locations is less than the second threshold distance. The route selection engine 206 may be realized by use of one or more mathematical models, one or more statistical models, one or more algorithms, or a combination thereof. Further, the route selection engine 206 may be implemented using an ASIC processor, a RISC processor, a CISC processor, an FPGA, or a combination thereof.

The speed detection engine 208 includes suitable logic, circuitry, and/or interfaces that are operable to execute instructions, codes, scripts, and programs stored in the memory 204 to perform one or more operations. In an embodiment, the speed detection engine 208 detects speed, for example, the walking speed of the passenger 104 and stores in the memory 204. The walking speed of the passenger 104 is an average of walking speeds of the passenger 104 detected by the speed detection engine 208 over a period of time by means of the installed service application on the passenger device 102. In another example, the speed detection engine 208 determines the walking speed of the passenger 104 based on an average of walking speeds of a set of passengers, which may or may not include the passenger 104, based on attributes, such as an age, a height, a gender, a weight, or the like, that are similar to that of the passenger 104. In another embodiment, the speed detection engine 208 detects speed of the one or more vehicles, such as the vehicle 112, based on vehicle motion information of the vehicle 112 when the vehicle 112 is being driven by the driver from one location to another location. The vehicle motion information may be obtained from the driver device 110 of the driver associated with the vehicle 112. In another example, the speed detection engine 208 may detect the speed of the vehicle 112 based on speed data received from a speed detecting sensor (not shown) installed or embedded inside the vehicle 112. The speed detection engine 208 may be realized by use of one or more mathematical models, one or more statistical models, one or more algorithms, or a combination thereof. Further, the speed detection engine 208 may be implemented using an ASIC processor, a RISC processor, a CISC processor, an FPGA, or a combination thereof.

The time calculator engine 210 includes suitable logic, circuitry, interfaces, and/or code that may be operable to execute instructions, codes, scripts, and programs stored in the memory 204 to perform one or more operations. The time calculator engine 210 determines the first time duration for the passenger 104 for reaching the pick-up location from the source location after allocation of the vehicle 112 to the passenger 104 for the ride. The time calculator engine 210 further determines the second time duration for each vehicle. The second time duration is determined based on the vehicle time duration for reaching the pick-up location from its current location and the waiting time duration of each vehicle at the pick-up location. The vehicle time duration for each vehicle may be determined based on at least a third distance between the current and pick-up locations, an average speed of each vehicle, and real-time traffic conditions between the current and pick-up locations. The time calculator engine 210 may be realized by use of one or more mathematical models, one or more statistical models, one or more algorithms, combination thereof. Further, the time calculator engine 210 may be implemented using an ASIC processor, a RISC processor, a CISC processor, an FPGA, or a combination thereof.

The fare calculator engine 212 includes suitable logic, circuitry, interfaces, and/or code that may be operable to execute instructions, codes, scripts, and programs stored in the memory 204 to perform one or more operations. For example, the fare calculator engine 212 calculates a ride fare for the ride requested by the passenger 104 based on at least one of a distance between the pick-up and drop-off locations along the selected route, a number of demands for vehicle services along the selected route, a number of passengers already traveling in the vehicle 112, or real-time traffic conditions between the pick-up and drop-off locations. The fare calculator engine 212 further stores the fare information including ride fares in the memory 204. The fare calculator engine 212 may be realized by use of one or more mathematical models, one or more statistical models, one or more algorithms, or a combination thereof. Further, the fare calculator engine 212 may be implemented using an ASIC processor, a RISC processor, a CISC processor, an FPGA, or a combination thereof.

The notification engine 214 includes suitable logic, circuitry, interfaces, and/or code that may be operable to execute instructions, codes, scripts, and programs stored in the memory 204 to perform one or more operations. The notification engine 214 retrieves the allocation, direction, and fare information from the memory 204 and transmits the notification message including at least one of the allocation, direction, or fare information to the passenger device 102 or the driver device 110 over the communication network 114. The notification engine 214 may be realized by use of one or more mathematical models, one or more statistical models, one or more algorithms, or a combination thereof. Further, the notification engine 214 may be implemented using an ASIC processor, a RISC processor, a CISC processor, an FPGA, or a combination thereof.

The vehicle allocation engine 216 includes suitable logic, circuitry, interfaces, and/or code that may be operable to execute instructions, codes, scripts, and programs stored in the memory 204 to perform one or more operations. In an embodiment, the vehicle allocation engine 216 allocates the vehicle 112 selected from the set of vehicles to the passenger 104. The vehicle 112 is selected, when the second time duration is greater than or equal to the first time duration and the vehicle 112 is nearest to the pick-up location among the set of vehicles in terms of distance. The vehicle allocation engine 216 further allocates the vehicle 112 to the passenger 104 based on drop-off locations of other passengers in the vehicle 112. In another embodiment, the vehicle allocation engine 216 allocates a new vehicle to the passenger 104 for the ride when no vehicle is identified from the set of vehicles for providing the ride to the passenger 104. The vehicle allocation engine 216 may be realized by use of one or more mathematical models, one or more statistical models, one or more algorithms, or a combination thereof. Further, the vehicle allocation engine 216 may be implemented using an ASIC processor, a RISC processor, a CISC processor, an FPGA, or a combination thereof.

The transceiver 218 includes suitable logic, circuitry, and/or interfaces that are operable to transmit (or receive) data to (or from) various devices, such as the passenger device 102 or the driver device 110, over the communication network 114. For example, the transceiver 218 receives the booking request from the passenger device 102 and stores it in the memory 204. The transceiver 218 further transmits the allocation information and the direction information to the passenger device 102 or the driver device 110. Examples of the transceiver 218 include, but are not limited to, an antenna, a radio frequency transceiver, a wireless transceiver, and a Bluetooth transceiver. The transceiver 218 communicates with the communication network 114 using various wired and wireless communication protocols, such as TCP/IP (Transmission Control Protocol/Internet Protocol), UDP (User Datagram Protocol), 2nd Generation (2G), 3rd Generation (3G), 4th Generation (4G), or 5th Generation (5G) communication protocols, or any combination thereof.

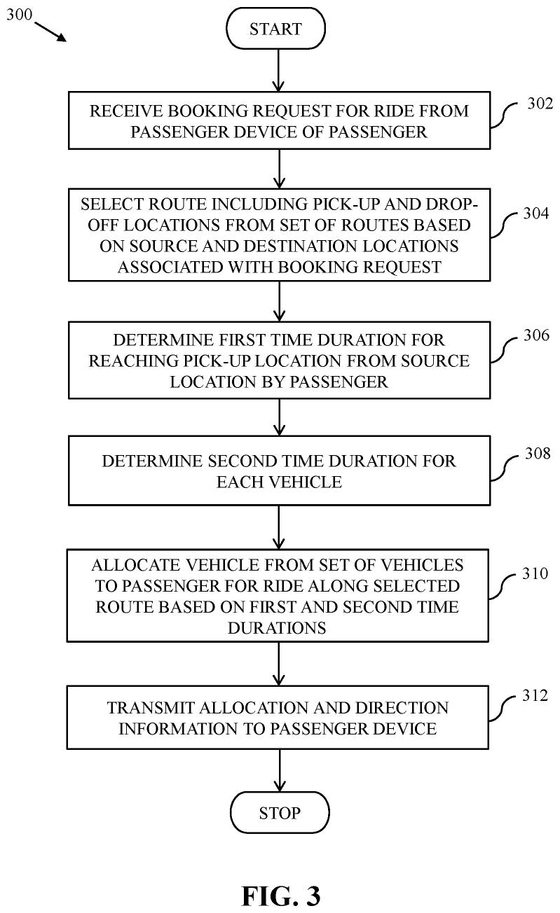

Referring now to FIG. 3, a flow chart 300 that illustrates a method for allocating the vehicle 112 to the passenger 104 of the environment of FIG. 1 is shown, in accordance with an embodiment of the present invention.

At step 302, the booking request for the ride is received from the passenger device 102 of the passenger 104. The processor 202 receives the booking request including at least the source and destination locations provided by the passenger 104 from the passenger device 102 by way of the transceiver 218 over the communication network 114. The booking request may further include other ride-related preferences provided by the passenger 104, for example, a preference for a vehicle type, a preference for a pick-up time, or the like. The processor 202 stores the received booking request in the memory 204.

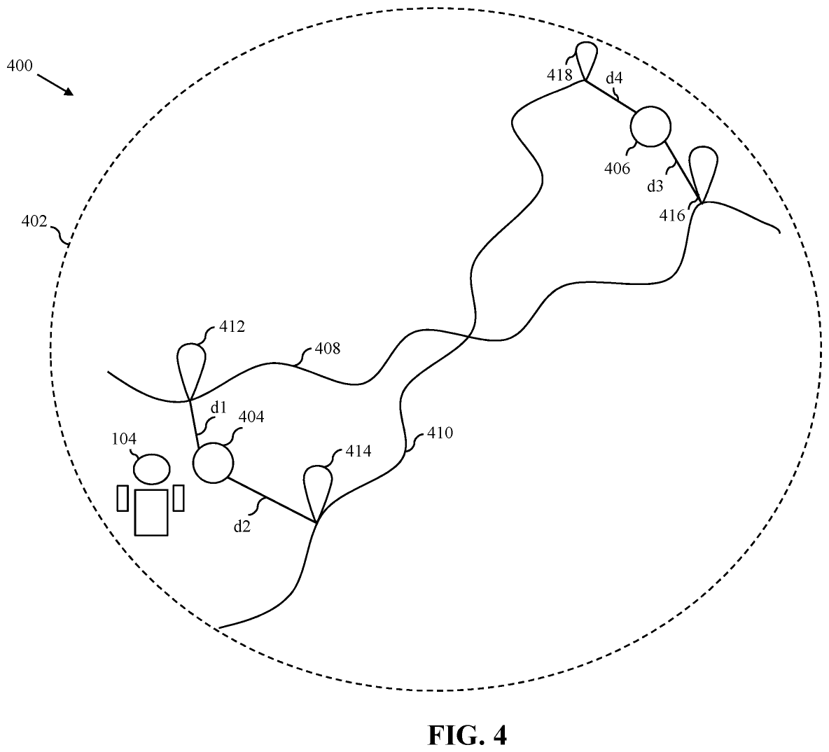

At step 304, the route for the ride requested by the passenger 104 is selected from the set of routes. The route selection engine 206 selects the route from the set of routes based on the source and destination locations associated with the booking request. In an embodiment, the route selection engine 206 selects the route including the pick-up and drop-off locations such that the first distance between the source and pick-up locations is less than the first threshold distance and the second distance between the destination and drop-off locations is less than the second threshold distance. The pick-up and drop-off locations along the selected route are identified based on the shortest approachable location points along the selected route from the source and destination locations, respectively. The selection of the route from the set of routes has been described later with an exemplary scenario in conjunction with FIG. 4.

At step 306, the first time duration is determined for reaching the pick-up location by the passenger 104 from the source location. The processor 202 provides the source and destination locations of the passenger 104 to the time calculator engine 210. The processor 202 further provides the pick-up and drop-off locations along the selected route to the time calculator engine 210. Thereafter, the time calculator engine 210 determines the first distance between the source and pick-up locations. In another embodiment, the time calculator engine 210 retrieves the first distance between the source and pick-up locations from the memory 204. Further, the time calculator engine 210 retrieves the walking speed of the passenger 104 from the memory 204. Thereafter, the time calculator engine 210 determines the travel time duration for the passenger 104 for reaching the pick-up location from the source location based on the first distance and the walking speed of the passenger 104. The time calculator engine 210 further obtains the buffer time duration from the memory 204 and adds the buffer time duration to the travel time duration to obtain the first time duration. The buffer time duration is the extra time duration in addition to the travel time duration that is provided to the passenger 104 for reaching the pick-up location so that the passenger 104 does not miss the allocated vehicle for the ride. The time calculator engine 210 stores the first time duration in the memory 204.

At step 308, the second time duration is determined for each vehicle from the set of vehicles that is behind the pick-up location and is traveling towards the drop-off location along the selected route. The time calculator engine 210 determines the second time duration based on the vehicle time duration of each vehicle and the waiting time duration associated with the pick-up location. In an embodiment, the vehicle time duration for each vehicle is the time duration for reaching the pick-up location from the current location of each vehicle. The time calculator engine 210 determines the vehicle time duration based on at least the third distance between the current and pick-up locations, the average speed of each vehicle, and the real-time traffic conditions between the current and pick-up locations along the selected route. The waiting time duration of each vehicle at the pick-up location is the time duration for which each vehicle may wait for the one or more passengers at the pick-up location before moving from the pick-up location towards the next pick-up or drop-off location along the selected route. The time calculator engine 210 stores the second time duration in the memory 204.

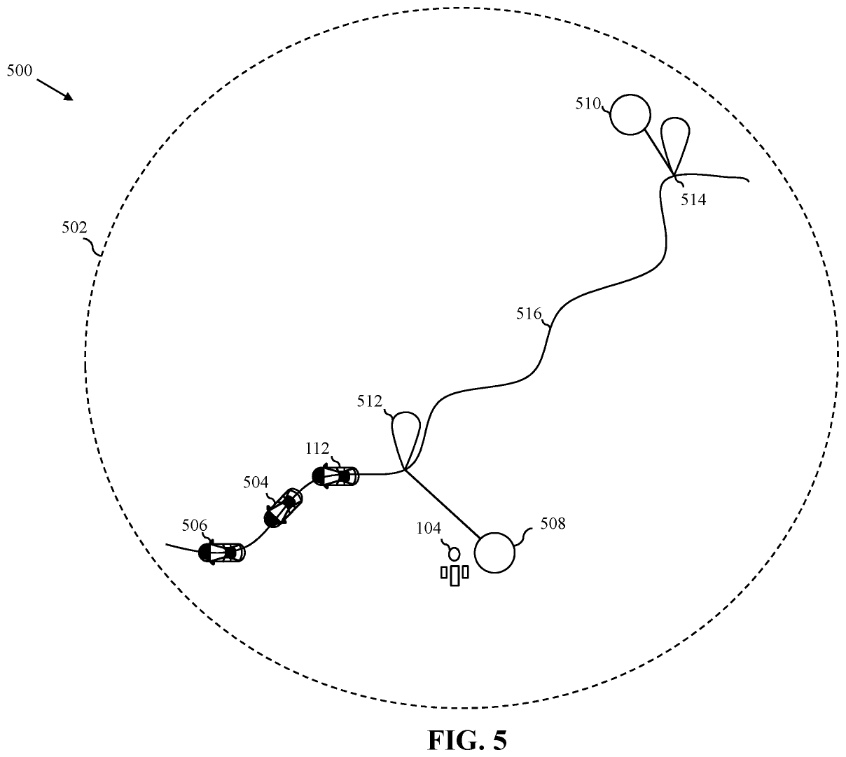

At step 310, the vehicle 112 from the set of vehicles is allocated to the passenger 104 for ride along the selected route based on first and second time durations. Prior to allocation of the vehicle 112 to the passenger 104, the vehicle allocation engine 216 retrieves the first and second time durations of each vehicle from the set of vehicles including the vehicle 112 from the memory 204. Thereafter, the vehicle allocation engine 216 selects one vehicle from the set of vehicles, such as the vehicle 112, based on the first and second time durations. The vehicle allocation engine 216 compares the first and second time durations to select the vehicle 112, when the second time duration associated with the vehicle 112 is greater than or equal to the first time duration associated with the passenger 104. Further, the vehicle 112 is the nearest to the pick-up location among the set of vehicles in terms of distance. Thereafter, the vehicle allocation engine 216 allocates the vehicle 112 to the passenger 104 for the ride. However, in a scenario where no vehicle is identified from the set of vehicles for providing the ride to the passenger 104, the vehicle allocation engine 216 allocates a new vehicle to the passenger 104 for the ride. The allocation of the vehicle 112 to the passenger 104 has been described later with an exemplary scenario in conjunction with FIG. 5.

After allocation of the vehicle 112 to the passenger 104, the notification engine 214 generates the allocation and direction information for the passenger 104 and the driver of the vehicle 112 and stores in the memory 204. The allocation information includes at least one of the pick-up and drop-off locations associated with the ride, the ride-start time from the pick-up location, the vehicle information of the vehicle 112, the passenger information of the passenger 104, or the driver information of the driver of the vehicle 112. The direction information associated with the passenger 104 includes one or more directions or ways for directing the passenger 104 from the source location to the pick-up location. The direction information associated with the driver includes one or more directions or ways for directing the driver of the vehicle 112 from the pick-up location to the drop-off location along the selected route.

At step 312, the allocation and direction information are transmitted to the passenger device 102. The notification engine 214 retrieves the allocation and direction information from the memory 204 and transmits the allocation and direction information to the passenger device 102 or the driver device 110 by way of the transceiver 218 over the communication network 114.

Referring now to FIG. 4, an exemplary environment 400 that illustrates selection of the route from the set of routes of the geographical area is shown, in accordance with an embodiment of the present invention. The exemplary environment 400 includes the geographical area 402 including the source location 404 and the destination location 406 associated with the booking request initiated by the passenger 104. The geographical area 402 further includes the set of routes, for example, a first route 408 and a second route 410. The geographical area further includes a first pick-up location 412, a second pick-up location 414, a first drop-off location 416, and a second drop-off location 418 that have been identified based on the source location 404 and the destination location 406 associated with the booking request. For example, the first pick-up location 412 and the first drop-off location 416 are the shortest approachable locations along the first route 408 from the source location 404 and the destination location 406, respectively. Similarly, the second pick-up location 414 and the second drop-off location 418 are the shortest approachable locations along the second route 410 from the source location 404 and the destination location 406, respectively.

In one example, the route selection engine 206 selects the first route 408 from the first and second routes 408 and 410, when a distance (d1) between the source location 404 and the first pick-up location 412 is less than a distance (d2) between the source location 404 and the second pick-up location 414 i.e., dl is less than d2 (d1<d2) and a distance (d3) between the destination location 406 and the first drop-off location 416 is less than a distance (d4) between the destination location 406 and the second drop-off location 418 i.e., d3 is less than d4 (d3<d4). Similarly, the route selection engine 206 selects the second route 410 from the first and second routes 408 and 410, when the distance (d1) between the source location 404 and the first pick-up location 412 is greater than the distance (d2) between the source location 404 and the second pick-up location 414 i.e., dl is greater than d2 (d1>d2) and the distance (d3) between the destination location 406 and the first drop-off location 416 is greater than the distance (d4) between the destination location 406 and the second drop-off location 418 i.e., d3 is greater than d4 (d3>d4).

In another example, the distance (d1) between the source location 404 and the first pick-up location 412 is less than the distance (d2) between the source location 404 and the second pick-up location 414. However, the distance (d3) between the destination location 406 and the first drop-off location 416 is greater than the distance (d4) between the destination location 406 and the second drop-off location 418. In such a scenario, the route selection engine 206 selects one of the first and second routes 408 and 410 based on a total walking distance associated with each of the first and second routes 408 and 410 that is to be walked by the passenger 104 during the ride. The total walking distance associated with the first route 408 includes a walking distance (d1) between the source location 404 and the first pick-up location 412 and a walking distance (d3) between the destination location 406 and the first drop-off location 416. Similarly, the total walking distance associated with the second route 410 includes a walking distance (d2) between the source location 404 and the second pick-up location 414 and a walking distance (d4) between the destination location 406 and the second drop-off location 418. Thus, the route selection engine 206 selects the first route 408 from the first and second routes 408 and 410, when d1+d3<d2+d4, and selects the second route 410 from the first and second routes 408 and 410, when d1+d3>d2+d4.

In yet another example, when d1+d3=d2+d4, the route selection engine 206 selects one of the first and second routes 408 and 410 based on a distance between the first pick-up location 412 and the first drop-off location 416 and a distance between the second pick-up location 414 and the second drop-off location 418. For example, the distance between the first pick-up location 412 and the first drop-off location 416 is “20 kilometers” and the distance between the second pick-up location 414 and the second drop-off location 418 is “10 kilometers” and d1+d3=d2+d4. In such a scenario, the route selection engine 206 selects the second route 410 from the first and second routes 408 and 410 as the distance (e.g., “10 kilometers”) is less than the distance (e.g., “20 kilometers”).

Referring now to FIG. 5, an exemplary environment 500 that illustrates allocation of the vehicle 112 in the geographical area 502 is shown, in accordance with an embodiment of the present invention. The geographical area 502 includes three vehicles, such as the vehicle 112, a vehicle 504, and a vehicle 506 that are available for allocation based on the booking request initiated by the passenger 104. The geographical area 502 further includes the source location 508, the destination location 510, the pick-up location 512, and the drop-off location 514. The pick-up location 512 and drop-off location 514 are associated with the route 516 selected from the set of routes identified in the geographical area 502.

The processor 202 receives the booking request from the passenger device 102 that includes the source location 508 and the destination location 510 of the passenger 104. The time calculator engine 210 determines the travel time duration for the passenger 104 to reach the pick-up location 512 from the source location 508. The processor 202 further determines the total time duration (i.e., the first time duration) for the passenger 104 to reach the pick-up location 512 that also includes the buffer time duration in addition to the travel time duration to reach the pick-up location 512 from the source location 508. In one example, the travel time duration for the passenger 104 to reach the pick-up location 512 from the source location 508 is determined as “5 minutes” and the buffer time duration as “1 minute”. Thus, the total time duration for the passenger 104 to reach the pick-up location 512 from the source location 508 is determined as “6 minutes” i.e., “5 minutes+1 minute”.

In the ongoing exemplary scenario, the processor 202 receives the current location information of each of the vehicles 112, 504, and 506 from the respective driver devices. The time calculator engine 210 further determines the vehicle time duration for each of the vehicles 112, 504, and 506 to reach the pick-up location 512 from their respective current locations. The processor 202 determines the total time duration (i.e., the second time duration) for the each of the vehicles 112, 504, and 506 to reach the pick-up location from their respective current locations based on the travel time duration and the waiting time duration of each vehicle at the pick-up location. For example, the processor 202 determines that the travel time durations of the vehicles 112, 504, and 506 are “6 minutes”, “7 minutes”, and “8 minutes”. respectively. The processor 202 further determines the waiting time duration at the pick-up location for each of the vehicles 112, 504, and 506 is “3 minutes”. Thus, the total time duration for each of the vehicles 112, 504, and 506 is “9 minutes(=6+3)”, “10 minutes(=7+3)”, and “11 minutes(=8+3)”, respectively. The vehicle allocation engine 216 then allocates the vehicle 112 to the passenger 104 as the total time duration (i.e., “9 minutes”) for the vehicle 112 to reach the pick-up location 512 is greater than the total time duration (i.e., “6 minutes”) for the passenger 104 to reach the pick-up location 512 from the source location 508 and the vehicle 112 is nearest to the pick-up location 512 in terms of distance, as shown.

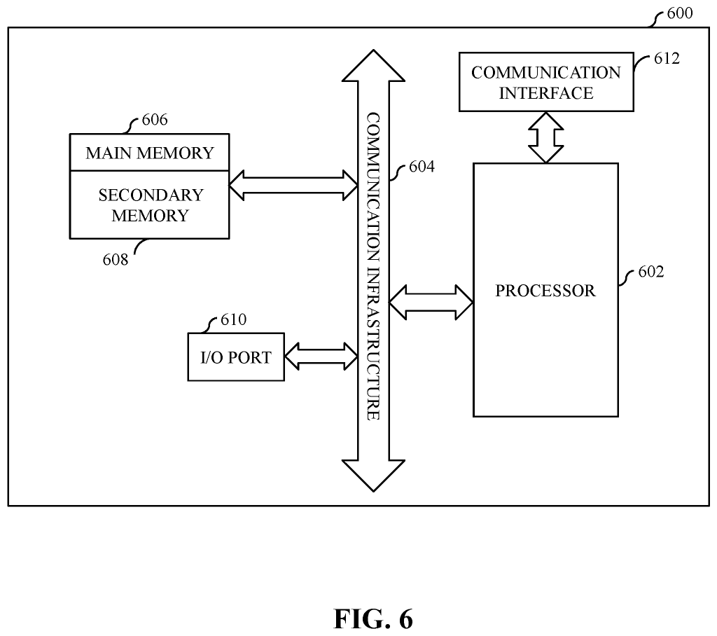

Referring now to FIG. 6, a block diagram that illustrates a computer system 600 for allocating the vehicle 112 to the passenger 104 is shown, in accordance with an embodiment of the present invention. An embodiment of the present invention, or portions thereof, may be implemented as computer readable code on the computer system 600. In one example, the application server 106 and the database server 108 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the method of FIG. 3.

The computer system 600 includes a processor 602 that may be a special purpose or a general-purpose processing device. The processor 602 may be a single processor, multiple processors, or combinations thereof. The processor 602 may have one or more processor “cores.” Further, the processor 602 may be connected to a communication infrastructure 604, such as a bus, a bridge, a message queue, the communication network 114, multi-core message-passing scheme, and the like. The computer system 600 further includes a main memory 606 and a secondary memory 608. Examples of the main memory 606 may include RAM, ROM, and the like. The secondary memory 608 may include a hard disk drive or a removable storage drive (not shown), such as a floppy disk drive, a magnetic tape drive, a compact disc, an optical disk drive, a flash memory, and the like. Further, the removable storage drive may read from and/or write to a removable storage device in a manner known in the art. In an embodiment, the removable storage unit may be a non-transitory computer readable recording media.

The computer system 600 further includes an I/O port 610 and a communication interface 612. The I/O port 610 includes various input and output devices that are configured to communicate with the processor 602. Examples of the input devices may include a keyboard, a mouse, a joystick, a touchscreen, a microphone, and the like. Examples of the output devices may include a display screen, a speaker, headphones, and the like. The communication interface 612 may be configured to allow data to be transferred between the computer system 600 and various devices that are communicatively coupled to the computer system 600. Examples of the communication interface 612 may include a modem, a network interface, i.e., an Ethernet card, a communications port, and the like. Data transferred via the communication interface 612 may be signals, such as electronic, electromagnetic, optical, or other signals as will be apparent to a person skilled in the art. The signals may travel via a communications channel, such as the communication network 114 which may be configured to transmit the signals to the various devices that are communicatively coupled to the computer system 600. Examples of the communication channel may include, but are not limited to, cable, fiber optics, a phone line, a cellular phone link, a radio frequency link, a wireless link, and the like.

Computer program medium and computer usable medium may refer to memories, such as the main memory 606 and the secondary memory 608, which may be a semiconductor memory such as dynamic RAMs. These computer program mediums may provide data that enables the computer system 600 to implement the method illustrated in FIG. 3. In an embodiment, the present invention is implemented using a computer implemented application. The computer implemented application may be stored in a computer program product and loaded into the computer system 600 using the removable storage drive or the hard disc drive in the secondary memory 608, the I/O port 610, or the communication interface 612.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor, such as the processor 602, and a memory, such as the main memory 606 and the secondary memory 608, implement the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present invention provide, among other features, systems and methods for allocating one or more vehicles to one or more passengers. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

What is claimed is:

1. A method for vehicle allocation, the method comprising:
receiving, by a server from a passenger device of a passenger over a communication network, a booking request for a ride including source and destination locations of the passenger;
selecting, by the server, a route including pick-up and drop-off locations from a set of routes based on the source and destination locations associated with the booking request such that a first distance between the source and pick-up locations is less than a first threshold distance and a second distance between the destination and drop-off locations is less than a second threshold distance;
determining, by the server, a first time duration including a buffer time duration for reaching the pick-up location by the passenger from the source location based on at least the first distance;
determining, by the server, a second time duration for each vehicle from a set of vehicles that is behind the pick-up location and is traveling towards the drop-off location along the selected route, based on a vehicle time duration for reaching the pick-up location from a current location of each vehicle and a waiting time duration of each vehicle at the pick-up location; and
allocating, by the server, a vehicle from the set of vehicles to the passenger for the ride along the selected route based on the first and second time durations, when the second time duration associated with the vehicle is greater than or equal to the first time duration and the vehicle is nearest to the pick-up location among the set of vehicles in terms of distance.

2. The method of claim 1, wherein the set of routes are identified in a geographical area based on a density of historical pick-up and drop-off locations associated with the geographical area.

3. The method of claim 1, wherein each route of the set of routes is a fixed route including one or more pick-up and drop-off locations that are dynamically identified based on one or more shortest approachable location points along each route from one or more source or destination locations associated with one or more booking requests.

4. The method of claim 1, wherein the first time duration is further determined based on a walking speed of the passenger.

5. The method of claim 1, wherein the vehicle time duration of each vehicle is determined based on at least a third distance between the current and pick-up locations and a real-time traffic condition between the current and pick-up locations.

6. The method of claim 1, wherein the vehicle is further allocated to the passenger based on drop-off locations of other passengers in the vehicle.

7. The method of claim 1, further comprising transmitting, by the server to the passenger device over the communication network, allocation information including the pick-up and drop-off locations of the ride, a ride-start time from the pick-up location, vehicle information of the allocated vehicle, and driver information of a driver of the allocated vehicle.

8. The method of claim 1, further comprising transmitting, by the server to the passenger device over the communication network, direction information for directing the passenger from the source location to the pick-up location.

9. The method of claim 1, further comprising allocating, by the server, a new vehicle to the passenger for the ride along the selected route when the set of vehicles is unavailable for providing the ride to the passenger.

10. A system for vehicle allocation in a share-ride system, the system comprising:
circuitry configured to:
receive, from a passenger device of a passenger over a communication network, a booking request for a ride including source and destination locations of the passenger;
select a route including pick-up and drop-off locations from a set of routes based on the source and destination locations associated with the booking request such that a first distance between the source and pick-up locations is less than a first threshold distance and a second distance between the destination and drop-off locations is less than a second threshold distance;
determine a first time duration including a buffer time duration for reaching the pick-up location by the passenger from the source location based on at least the first distance;
determine a second time duration for each vehicle from a set of vehicles that is behind the pick-up location and is traveling towards the drop-off location along the selected route, based on a vehicle time duration for reaching the pick-up location from a current location of each vehicle and a waiting time duration of each vehicle at the pick-up location; and
allocate a vehicle from the set of vehicles to the passenger for the ride along the selected route based on the first and second time durations, when the second time duration associated with the vehicle is greater than or equal to the first time duration and the vehicle is nearest to the pick-up location among the set of vehicles in terms of distance.

11. The system of claim 10, wherein the circuitry is further configured to identify the set of routes in a geographical area based on a density of historical pick-up and drop-off locations associated with the geographical area.

12. The system of claim 10, wherein each route of the set of routes is a fixed route including one or more pick-up and drop-off locations that are identified dynamically based on one or more shortest approachable location points along each route from one or more source or destination locations associated with one or more booking requests.

13. The system of claim 10, wherein the circuitry is further configured to determine the first time duration based on a walking speed of the passenger.

14. The system of claim 10, wherein the circuitry is further configured to determine the vehicle time duration of each vehicle based on at least a third distance between the current and pick-up locations and a real-time traffic condition between the current and pick-up locations.

15. The system of claim 10, wherein the circuitry is further configured to allocate the vehicle to the passenger based on drop-off locations of other passengers in the vehicle.

16. The system of claim 10, wherein the circuitry is further configured to transmit allocation information to the passenger device over the communication network, wherein the allocation information comprises the pick-up and drop-off locations of the ride, a ride-start time from the pick-up location, vehicle information of the allocated vehicle, and driver information of a driver of the allocated vehicle.

17. The system of claim 10, wherein the circuitry is further configured to transmit direction information to the passenger device over the communication network for directing the passenger from the source location to the pick-up location.

18. The system of claim 10, wherein the circuitry is further configured to allocate a new vehicle to the passenger for the ride along the selected route when the set of vehicles is unavailable for providing the ride to the passenger.
